(19) United States
(12) Patent Application Publication
(10) Pub. No.: US 2014/0253327 A1
(43) Pub. Date: Sep. 11, 2014

(54) WHOLE HOME EMERGENCY ALERT SYSTEM

(71) Applicant: VOXX International Corporation, Hauppauge, NY (US)

(72) Inventors: Prapan Paul Tinaphong, Carmel, IN (US); Dennis A. Rosiak, Noblesville, IN (US); James K. Rinehart, Indianapolis, IN (US)

(73) Assignee: VOXX International Corporation, Hauppauge, NY (US)

(21) Appl. No.: 14/196,573

(22) Filed: Mar. 4, 2014

Related U.S. Application Data
(60) Provisional application No. 61/776,191, filed on Mar. 11, 2013.

(51) Int. Cl. G08B 21/10; G08B 17/117; G08B 21/14

(52) U.S. Cl. CPC G08B 21/10; G08B 21/14; G08B 17/117
USPC 340/539.14

(57) ABSTRACT

A whole home emergency alert system includes a base unit and a plurality of satellite units remotely located from the base unit and from each other. The base unit communicates wirelessly with the satellite units. The base unit receives NOAA and NWS alert signals, and transmits emergency alert signals to the plurality of satellite units.

### CROSS-REFERENCE TO RELATED APPLICATIONS

This application is related to U.S. Provisional Application Ser. No. 61/776,191, filed on Mar. 11, 2013, and entitled “Whole Home Emergency Alert System”, the disclosure of which is incorporated herein by reference and on which priority is hereby claimed.

### BACKGROUND OF THE INVENTION

1. Field of the Invention

The present invention relates to emergency alert systems, and more particularly relates to emergency alert systems for use in apartment buildings, business offices and residential premises having multiple rooms.

2. Description of the Prior Art

With the advent of high-quality satellite and radar imaging systems and their ability to accurately forecast future weather events, the weather is becoming of greater interest to the average person. Weather reports are currently broadcast over seven (7) weather band radio signals in the VHF band, which are between about 162.400 MHZ and 162.550 MHZ.

The National Oceanic and Atmospheric Administration (NOAA) provide these weather band signals. Radios must be specially designed to receive these signals since they are outside the normal AM, FM and XM (digital radio) bands.

Weather reports are repeated at intervals of about 4 to 6 minutes and are updated every 1 to 6 hours or even more frequently when conditions are changing rapidly. These reports may include severe weather warnings that threaten public safety.

The NOAA began broadcasting special codes called FIPS (Federal Information Processing System) codes with the weather reports in 1994. FIPS codes indicate the type of emergency and the geographic area affected by the emergency.

The NWS (National Weather Service) has assigned different 6-digit FIPS codes to each county or parish in the United States. The first digit of the FIPS code represents a county subdivision, the next two digits represent the state, and the final three digits represent the county or parish. Currently, most FIPS codes begin with 0, which indicates that the code corresponds to an entire county or parish.

Radios specially equipped with a feature known as “SAME” (Specific Area Message Encoding) will only alert the listener to an emergency in the listener's area. These radios do this by comparing the transmitted FIPS code to the FIPS code corresponding to the listener's area, which is programmed into the radio. When the two codes match, the radio alerts the listener and displays the type of emergency.

One of the problems with such conventional emergency radios is that they may only alert the occupants of the immediate area, such as a room, in which the radio is located. An occupant, such as a child, in a remote bedroom, for instance, may not hear the emergency warning of an approaching tornado or other severe weather condition which is audibly broadcast by the speaker or transducer of the emergency radio and thus may not be aware of the impending emergency to take evasive action.

### OBJECTS AND SUMMARY OF THE INVENTION

It is an object of the present invention to provide an emergency alert system which is designed to alert occupants of a residence or office in remote locations of the existence of an emergency.

It is another object of the present invention to provide an emergency alert system which is operational throughout an entire residence or office and which allows occupants in remote locations of the residence or office to communicate with one another when alerted of an emergency.

It is still another object of the present invention to provide a whole home emergency alert system which overcomes the inherent disadvantages of conventional emergency alert radios.

In accordance with one form of the present invention, a whole home emergency alert system includes a base unit and a plurality of satellite units. The base unit may be in the form of a digital clock radio receiving conventional FM and AM signals, but also configured to receive NOAA and SAME emergency signals. Thus, the base unit includes a receiver capable of receiving signals in the emergency frequency bands, and also a transmitter which is capable of transmitting a signal to each of the remotely located satellite units. The base unit includes an audio amplifier and a speaker or transducer, forming part of the receiver circuit, which broadcasts an audible warning or tone of an emergency situation, such as a severe weather condition, which may be heard by persons in the immediate area or room where the base unit is located.

Each remotely located satellite unit includes a receiver which is capable of receiving the warning signal transmitted by the base unit and, like the base unit, includes an audio amplifier and a speaker or transducer to sound an audible warning or emit a tone which may be heard in the remote locations where the satellite units are located. Preferably, each satellite unit also includes a transmitter to allow the persons where the satellite units are located to communicate with persons in proximity to where the base unit is located.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1A is a front perspective view of one form of a base unit forming part of the whole home emergency alert system of the present invention.

FIG. 1B is a top perspective view of the base unit of the whole home emergency alert system of the present invention and shown in FIG. 1A.

FIG. 1C is a side perspective view of the base unit of the whole home emergency alert system of the present invention and shown in FIGS. 1A and 1B.

FIG. 1D is a front perspective view of one form of a satellite unit of the whole home emergency alert system of the present invention.

FIG. 1E is a front perspective view of the satellite unit of the whole home emergency alert system of the present invention shown in FIG. 1D, illustrated mounted on an AC power wall outlet.

FIG. 2A is a front perspective view of another form of a base unit forming part of the whole home emergency alert system of the present invention.

FIG. 2B is a top perspective view of the base unit of the whole home emergency alert system of the present invention and shown in FIG. 2A.

FIG. 2C is a side perspective view of the base unit of the whole home emergency alert system of the present invention and shown in FIGS. 2A and 2B.

FIG. 2D is a front perspective view of another form of a satellite unit of the whole home emergency alert system of the present invention.

FIG. 2E is a front perspective view of the satellite unit of the whole home emergency alert system of the present invention shown in FIG. 2D, illustrated mounted on an AC power wall outlet.

FIG. 3 is a pictorial illustration of the whole home emergency alert system of the present invention, and illustrating how a base unit of the emergency alert system of the present invention communicates with a plurality of satellite units also forming part of the emergency alert system of the present invention.

FIG. 4 is a simplified block diagram of an electronic circuit used in the base unit of the whole home emergency alert system of the present invention.

FIG. 5 is a simplified block diagram of an electronic circuit used in each of the satellite units of the whole home emergency alert system of the present invention.

### DETAILED DESCRIPTION OF THE PREFERRED EMBODIMENTS

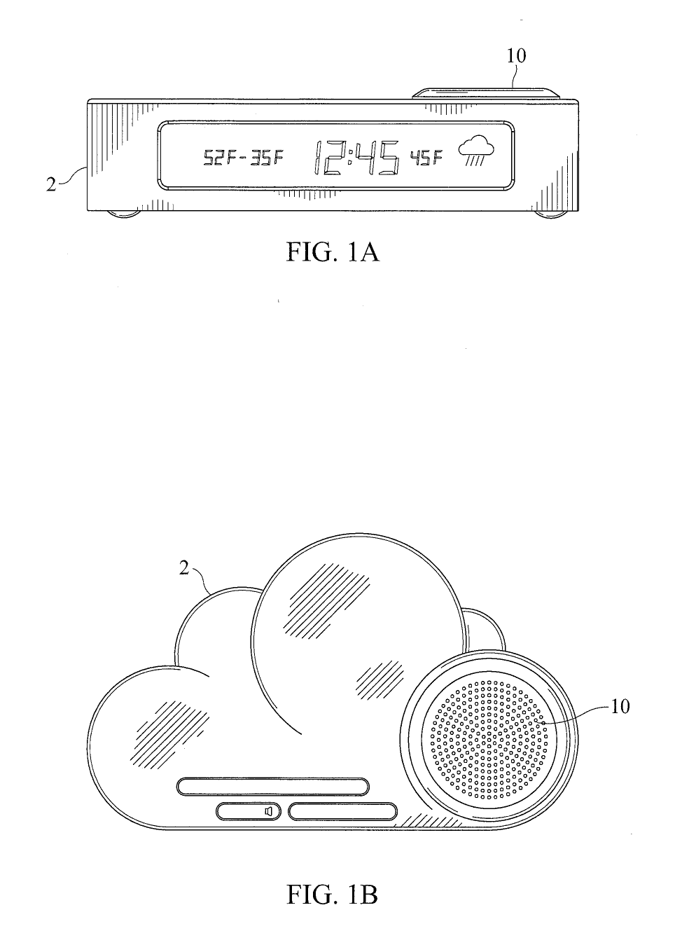

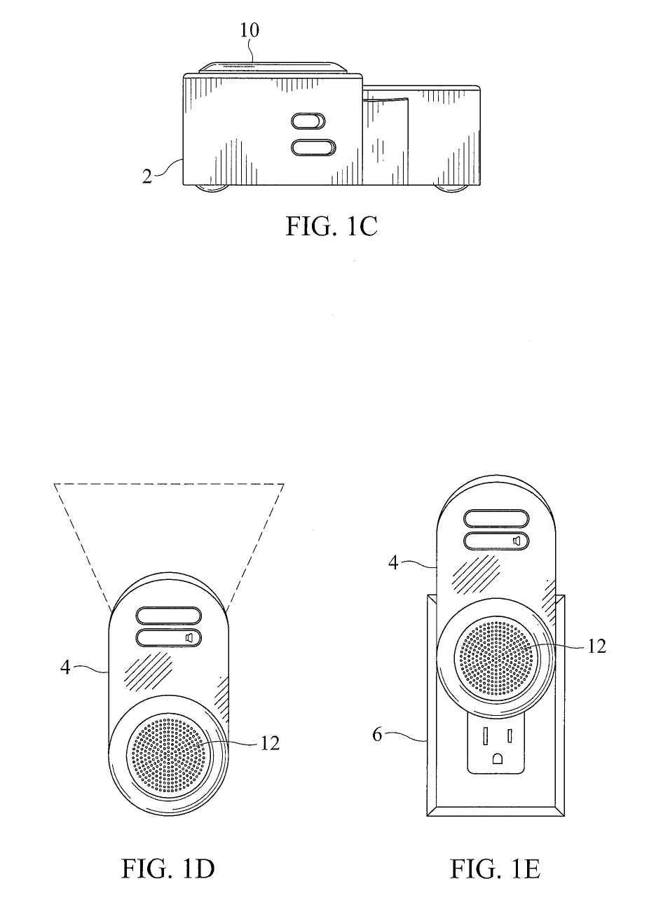

Reference should be had initially to FIGS. 1A-1C of the drawings, which illustrate one form of a base unit 2 forming part of the whole home emergency alert system 3 of the present invention, and FIGS. 1D and 1E, which illustrate one form of a satellite unit 4 also forming part of the whole home emergency alert system 3 of the present invention. More specifically, the base unit 2 of the emergency alert system 3 may be in the form of a digital AM/FM clock radio, and the circuit designed to detect and transmit a warning signal may be incorporated into such a digital clock radio.

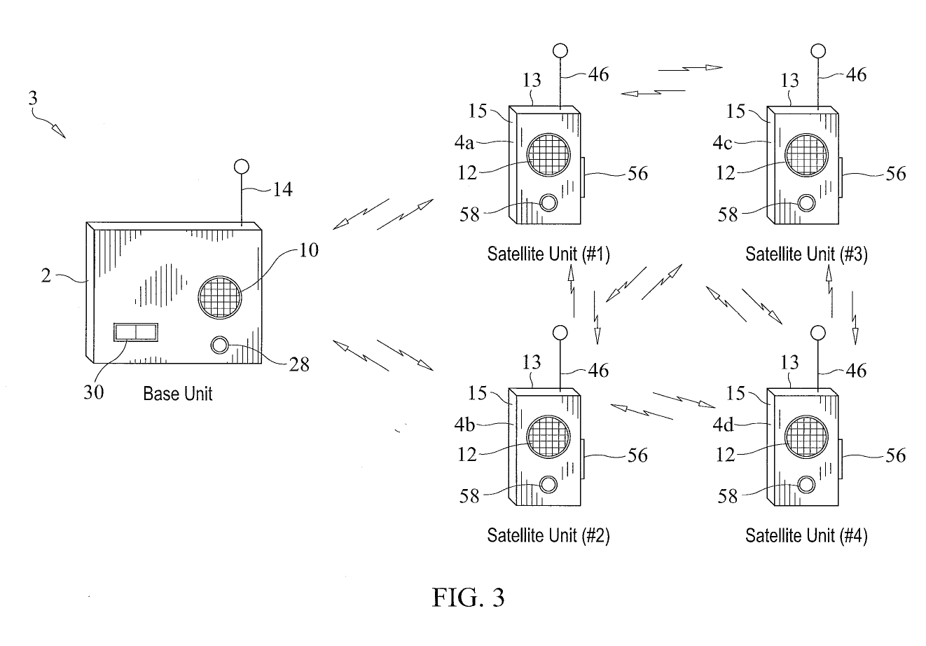

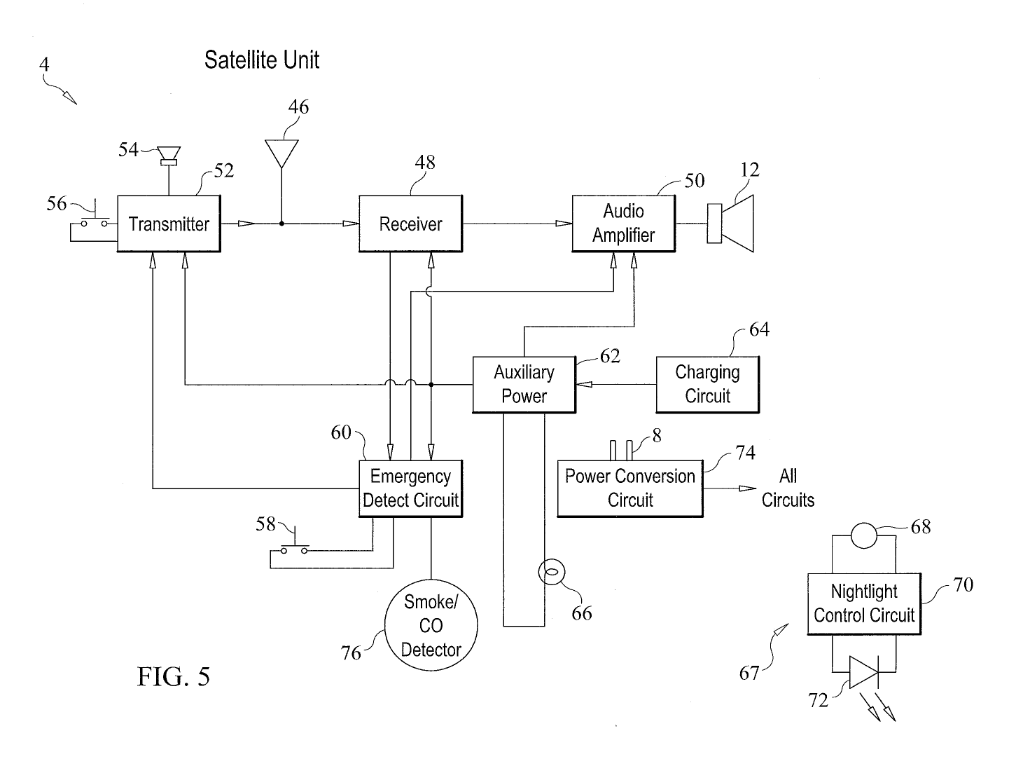

The base unit 2 communicates with a plurality of satellite units 4, one of which is shown in FIGS. 1D and 1E of the drawings. The satellite units 4 may be smaller than the base unit 2, and in a preferred form, may be mounted directly on, and receive power from, a typical AC power wall outlet 6 found in residences and offices. For this purpose, each satellite unit 4 includes AC power prongs 8 (see FIG. 5) extending outwardly from the rear wall 13 of the housing 15 (see FIG. 3) of the satellite unit 4, the prongs 8 being received by a receptacle of an AC power wall outlet 6.

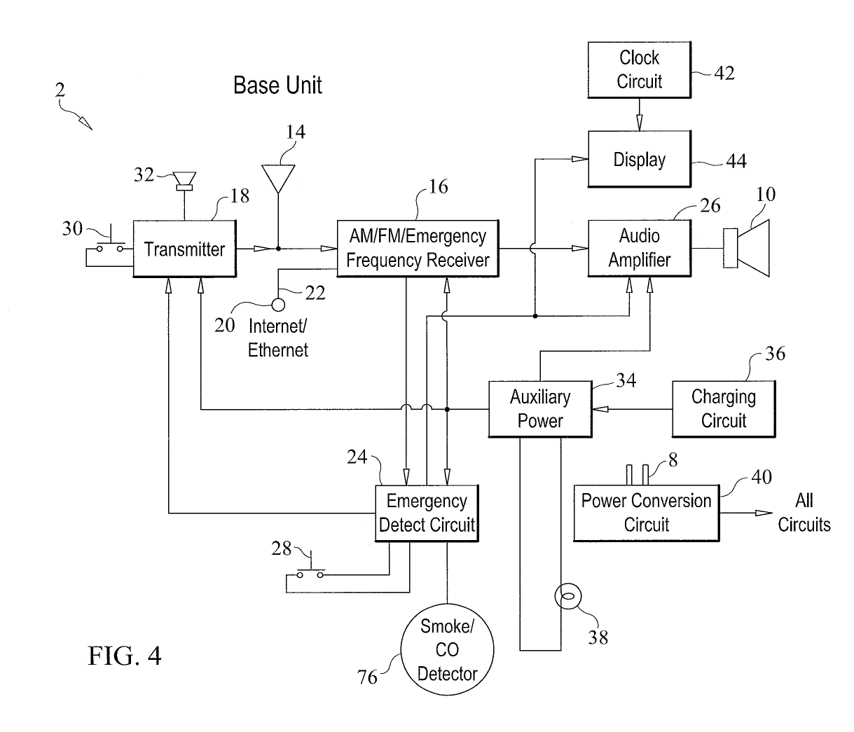

As can be seen in FIGS. 1A-1C, the base unit 2 includes a speaker 10 or other form of a transducer, and similarly, the satellite units 4 also include a speaker 12 or other form of a transducer. The speakers or transducers 10,12 are provided not only to emit an audible tone or pre-recorded message, alerting the occupants of the premises in which the emergency alert system 3 is situated of an emergency, but also to allow the occupants to communicate between the base unit 2 and the satellite units 4 in an intercom fashion via microphone 32 of base unit 2 (see FIG. 4) and microphone 54 of satellite unit 4 (see FIG. 5).

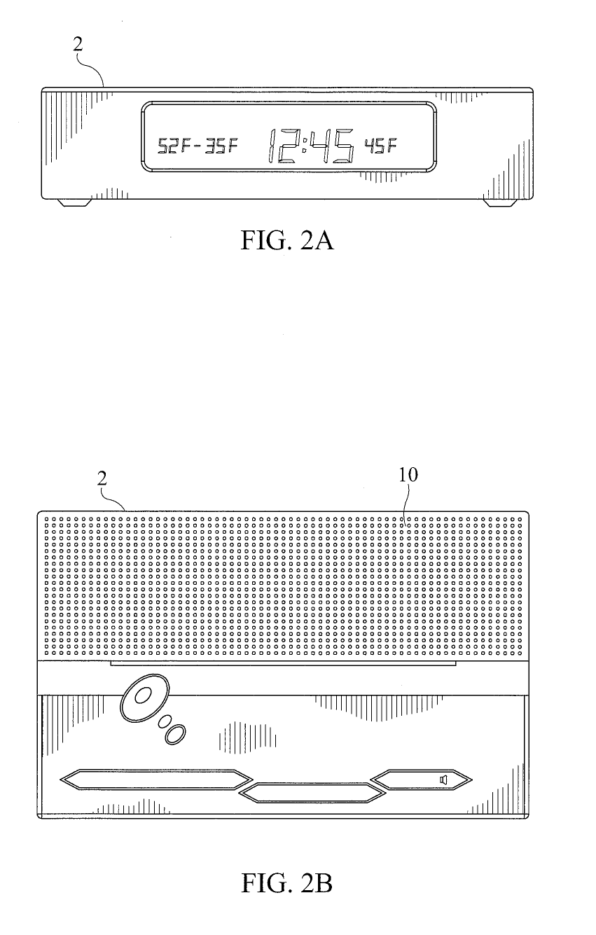

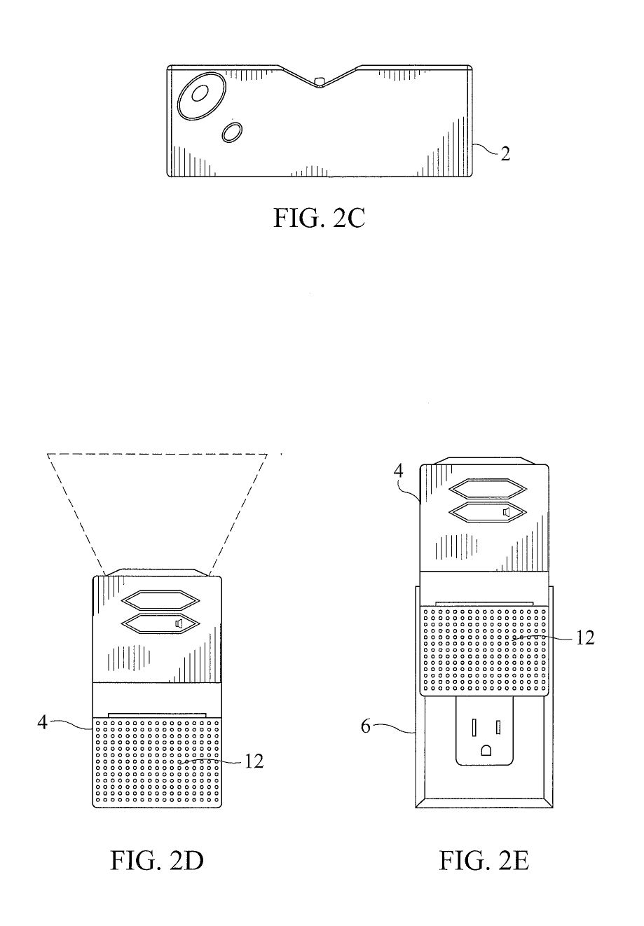

Another form of the base unit 2, also constructed as a digital AM/FM clock radio, is shown in FIGS. 2A-2C, and another form of a satellite unit 4 is shown in FIGS. 2D and 2E. The base unit 2 and satellite unit 4 shown in FIGS. 2A-2E include similar structure and circuitry, and function in a similar manner, to the base unit 2 and satellite unit 4 shown in FIGS. 1A-1E.

FIG. 3 illustrates the configuration of the whole home emergency alert system 3 of the present invention and the ability of the base unit 2 to communicate with one or more satellite units 4a-4d, and the ability of the satellite units 4 to communicate not only with the base unit 2 but also with other satellite units 4. The base unit 2 of the whole home emergency alert system 3 of the present invention monitors the emergency frequencies of the NOAA and the National Weather Service (NWS), and detects when an alert signal is broadcast and received by the base unit 2. Once such an emergency alert signal is received, the base unit 2 will emit a tone or provide an audible, pre-recorded message on the speaker 10, and will also transmit an emergency alert signal to each of the satellite units 4.

The satellite units 4 may be located remotely from the base unit 2, that is, in other rooms or areas of the residential premises or office building that may be out of earshot of the base unit 2 and where occupants may be present. The satellite units 4 receive the emergency alert signal transmitted by the base unit 2, and in response thereto, also emit a tone or an audible, pre-recorded message on the speakers 12 of the satellite units 4 to alert persons in proximity to the satellite units 4 of an emergency. Persons may then use the satellite units 4 to communicate by voice with the base unit 2 and any persons in proximity to the base unit 2, or may communicate by voice between satellite units 4 and persons in proximity to the satellite units 4.

Emergency signals broadcast by the base unit 2 to the satellite units 4 may be weather related, such as the approach of a tornado or another severe weather pattern, such as broadcast by the NOAA and the National Weather Service (NWS). But also, it is envisioned that a person at the base unit 2 may detect an emergency not weather-related and not broadcast by one of the federal agencies, but rather may include a fire, burglary, amber alert or panic alert, each of these being initiated by a person operating the base unit 2. Similarly, a person detecting a fire, burglary or other emergency at a remote location where a satellite unit 4 is situated may cause the satellite unit 4 to transmit an emergency alert signal to the other satellite units 4 and the base unit 2. In this manner, all occupants of a residence or office building, or apartment building, through which the satellite units 4 and base unit 2 are distributed will receive a warning signal of the emergency even though they may be out of earshot of the unit 2,4 which transmits the emergency signal. It should be further noted that, although it is envisioned to receive an emergency alert signal broadcast wirelessly by the NOAA or National Weather Service at certain emergency frequencies, it is also envisioned that the base unit 2 may be connected to the internet either wirelessly or through a pre-wired ethernet connection in the premises in which the emergency alert system is situated and receive an emergency alert signal broadcast over the internet, and react accordingly.

FIG. 4 is a simplified block diagram of an electronic circuit which may be used with the base unit 2 of the whole home emergency alert system 3 of the present invention. As mentioned previously, the electronic circuit for the base unit 2 may operate in conjunction with the electronic circuit of a typical digital AM/FM clock radio, although this need not be the case.

More specifically, the electronic circuit for the base unit 2 includes an antenna 14 which is connected to the input of an AM/FM/emergency frequency receiver circuit 16, and also to the output of a transmitter circuit 18. The receiver circuit 16 receives not only the customary AM/FM frequency band signals, but also emergency signals broadcast on certain reserved frequency bands, such as between 162.400 MHZ and 162.550 MHZ, such as those transmitted by the NOAA or other federal agencies. As mentioned previously, the receiver circuit 16 may be connected wirelessly to the internet 20 or through an appropriate cable 22 for an ethernet connection for receiving emergency signals over the internet 20.

When the receiver circuit 16 receives an emergency frequency signal, it sends the signal to an emergency detect circuit 24, which determines from the FIPS code whether the emergency signal that is broadcast is meant as a warning for the geographical location where the emergency alert system 3 is located. The emergency detect circuit 24 compares a FIPS (Federal Information Processing System) code received by the receiver circuit 16 to a FIPS code corresponding to the user's location and/or another FIPS code programmed into the base unit 2. If the emergency detect circuit 24 determines that the warning broadcast by the NOAA or other federal agency is meant for the particular geographical location where the emergency alert system 3 is located, then it sends a signal to the transmitter circuit 18 to transmit an emergency alert signal through the antenna 14 to the satellite units 4 forming part of the whole home emergency alert system 3 and situated in locations which are remote from the base unit 2.

As is also shown in FIG. 4 of the drawings, the receiver circuit 16 is connected to an audio amplifier circuit 26 which may form part of the conventional electronic circuit of a digital clock radio. The emergency detect circuit 24 also is connected to the audio amplifier circuit 26 and sends a signal to the audio amplifier circuit 26, such as a tone or a pre-recorded audible message. A speaker 10, connected to the audio amplifier circuit 26, will sound a loud tone or audible pre-recorded message so that anyone in the vicinity of the base unit 2 will be forewarned of the emergency condition.

The user of the base unit 2 of the emergency alert system 3 may broadcast an emergency signal not only audibly through the speaker 10 of the base unit 2 but also transmit an emergency alert signal to the remote satellite units 4. In addition, the user may press a panic, push button switch 28 connected to the emergency detect circuit 24 of the base unit 2 which, in response thereto, will send emergency alert signals to the transmitter 18 and audio amplifier circuit 26 of the base unit 2 for respectively transmitting the signal to the remote satellite units 4 and broadcasting an audible tone or audible pre-recorded message through the speaker 10 of the base unit 2.

As also mentioned previously, the user of the base unit 2 may communicate by voice through the base unit 2 with the satellite units 4. A push-to-talk (PTT) momentary push button switch 30 is connected to the transmitter circuit 18 of the base unit 2. A microphone 32 connected to the transmitter circuit 18 may be spoken into by the user when the PTT switch 30 is depressed. In response, the transmitter circuit 18 will transmit modulated voice signals on a carrier frequency via the antenna 14 to the remote satellite units 4. Alternatively, instead of a separate microphone 32, the user may speak into the speaker 10 which may act as a microphone and which may be selectively connected to the transmitter circuit 18 which transmits modulated voice signals on a carrier frequency to the remote satellite units 4 so that the base unit 2 may act as an intercom with the satellite units 4.

In a preferred form of the whole home emergency alert system 3 of the present invention, the base unit 2 may include an auxiliary power device 34, such as a battery. The base unit 2, like the satellite units, is connected to a standard power outlet 6 carrying 120 volts AC in the residence or office building where the emergency alert system 3 of the present invention is situated. In the event of a loss of power, the electronic circuit of the base unit 2 will remain operational and be powered by the auxiliary power device 34, or battery, until power is restored. A charging circuit 36 connected to the auxiliary power device 34 will recharge the auxiliary power device 34.

Also, as shown in FIG. 4 of the drawings, the base unit 2 may include an emergency light 38, such as an incandescent bulb or light emitting diode (LED), which is illuminated by the auxiliary power device 34, or battery, in the event of a power outage. Furthermore, the electronic circuit of the base unit 2 includes a power conversion circuit 40, which converts the 120 volts AC power of a typical power outlet 6 to which the base unit 2 is normally connected to a lower useable DC voltage for powering the electronic circuit of the base unit 2.

The electronic circuit of the base unit 2 shown in FIG. 4 also includes a clock circuit 42 and a display 44 to display the time or AM and FM stations, as it is envisioned to incorporate the electronic circuit of the base station 2 into a digital AM/FM clock radio. The display 44 of the clock radio, however, may also be connected to the emergency detect circuit 24 to display a pre-recorded warning of an emergency thereon.

FIG. 5 is a simplified block diagram of an electronic circuit which may be used in each of the satellite units 4 of the whole home emergency alert system 3 of the present invention. The satellite unit 4 includes much of the same circuitry as is found in the base unit 2, except that the circuitry associated with the AM/FM digital clock radio is preferably omitted from the satellite units 4. Also, each satellite unit 4 is envisioned to be smaller in size than the base unit 2, and is mountable on and receives power from a typical AC power wall outlet 6 found in residences and office buildings.

More specifically, the satellite unit 4 includes an antenna 46 which is connected to a receiver circuit 48. The receiver circuit 48 is constructed to receive emergency signals transmitted by either the base station 2 or another satellite unit 4. The receiver circuit 48 demodulates an emergency alert signal from the carrier signal, and provides the demodulated signal to an audio amplifier circuit 50, whose output is connected to a speaker 12. The audio amplifier circuit 50 will cause the speaker 12 to sound an audible alarm, such as a tone, or an audible pre-recorded message, warning of the emergency condition.

Each satellite unit 4 also includes a transmitter circuit 52. The transmitter circuit 52 is also connected to the antenna 46 and may be used to retransmit the received emergency alert signal to other satellite units 4 in a repeater-like fashion, in the event that some of the satellite units 4 are located outside of the broadcast signal range of the base unit 2 but may be closer to one or more of the satellite units 4.

Like the base unit 2, each satellite unit 4 may be used for voice communications with the base unit 2 or other satellite units 4. The transmitter circuit 52 of the satellite unit 4 may be connected to a microphone 54 or selectively connected to the speaker 12, and used to transmit voice messages through the antenna 46 to the base unit 2 and other satellite units 4, thereby functioning as an intercom. The satellite unit 4 also includes a push-to-talk (PTT) momentary push button switch 56 connected to the transmitter circuit 52, which the user may operate to transmit a voice message to the base unit 2 or other satellite units 4.

Each satellite unit 4 may also include a panic, push button switch 58 connected to an emergency detect circuit 60, which emergency detect circuit 60, upon activation of the panic switch 58, generates an output signal which is provided to the transmitter circuit 52 and the audio amplifier circuit 50 of the satellite unit 4 to transmit an emergency alert signal to the base unit 2 or other satellite units 4 and to cause the audio amplifier circuit 50 to emit a tone or an audible pre-recorded message on the speaker 12 connected thereto.

Preferably, the satellite unit 4 also includes an auxiliary power device 62, such as a battery, in the event of a power outage. A charging circuit 64 connected to the auxiliary power device 62 and to the AC power prongs 8 extending from the housing of the satellite unit 4 and which are received by the receptacle of the AC power wall outlet 6, is used to recharge the auxiliary power device 62, or battery. Also, the satellite unit 4 may include an emergency light 66, such as an incandescent bulb or an LED, for example, which is connected to the auxiliary power device 62, and which may illuminate and be used as emergency lighting in the event of a power failure.

The satellite unit 4 may also include a nightlight feature, which provides lighting to the area of the room in proximity to the satellite unit 4. A photocell or sensor 68 mounted on the housing of the satellite unit 4 may be used to detect the ambient light conditions in the room in which the satellite unit 4 is located. The photocell 68 is connected to a control circuit 70, which controls power to the nightlight 72, which also may be in the form of an LED or incandescent bulb, and will cause the nightlight 72 to illuminate when low ambient light conditions are detected by the photocell 68. The photocell 68, control circuit 70, nightlight 72 (LED, for example) and other components of the electronic circuit of the satellite unit 4 may all be powered by a power conversion circuit 74, which power conversion circuit 74 converts the 120 volt AC power from the wall outlet 6 to a lower useable DC voltage for powering the electronic circuit of the satellite unit 4.

Each of the base unit 2 and satellite units 4 may include a smoke detector and/or a carbon monoxide detector 76. The smoke detector/carbon monoxide detector 76 is connected to the emergency detect circuit 24,60. When a smoke condition or carbon monoxide is detected, the smoke detector/carbon monoxide detector 76 sends a signal to the emergency detect circuit 24,60 to which it is connected and, in response to this signal, the emergency detect circuit 24,60 will send a signal to the transmitter circuit 18,52 and the audio amplifier circuit 26,50 to transmit an emergency alert signal to the other units 2,4 in the system and to sound a tone or an audible pre-recorded message through the unit's speaker 10,12.

Preferably, the base unit 2 and the satellite units 4 communicate with one another within the ISM frequency band range from 240 MHZ to 930 MHZ, or even more preferably, at a frequency of 350 MHZ or 433 MHZ. Furthermore, in an emergency, or when needed as a flashlight, the satellite units 4 may be removed from the AC power wall outlet 6, and used as a handheld emergency flashlight and walkie talkie-type communicator.

Various embodiments of the whole home emergency alert system 3 will now be further described in detail. Basically, the whole home emergency alert system 3 includes a base unit 2, and at least one satellite unit 4, the at least one satellite unit 4 being remotely situated from the base unit 2. The base unit 2 communicates wirelessly with the at least one satellite unit 4. The base unit 2 includes an emergency signal receiver circuit 16 which receives at least one of an NOAA (National Oceanic and Atmospheric Administration) alert signal and an NWS (National Weather Service) alert signal. The base unit 2 further includes a transmitter circuit 18, the base unit transmitter circuit 18 being electrically coupled to the base unit receiver circuit 16 and transmitting an emergency alert signal to the at least one satellite unit 4 in response to the base unit receiver circuit 16 receiving the at least one of the NOAA alert signal and the NWS alert signal.

The base unit 2 further includes an audio amplifier circuit 26 and a transducer 10 electrically coupled to the base unit audio amplifier circuit 26, the base unit audio amplifier circuit 26 being electrically coupled to the base unit receiver circuit 16 and causing the base unit transducer 10 to emit an audible warning signal in response to the base unit receiver circuit 16 receiving the at least one of the NOAA alert signal and the NWS alert signal.

The at least one satellite unit 4 includes a receiver circuit 48 which receives the emergency alert signal transmitted by the base unit 2, and further includes an audio amplifier circuit 50 and a transducer 12 electrically coupled to the satellite unit audio amplifier circuit 50. The satellite unit audio amplifier circuit 50 is electrically coupled to the satellite unit receiver circuit 48 and causes the satellite unit transducer 12 to emit an audible warning signal in response to the satellite unit receiver circuit 48 receiving the emergency alert signal transmitted by the base unit 2.

The system 3 may include several satellite units 4a-4d (see FIG. 3) which can communicate with the base unit 2 and with each other. Preferably, therefore, each satellite unit 4a-4d includes a receiver circuit 48, a transmitter circuit 52, an audio amplifier circuit 50 and a transducer 12, and may further include other components, such as a panic switch 58, a microphone 54, an emergency light circuit having an auxiliary power circuit 62 and emergency light 66, a nightlight circuit 67 and a smoke detector and/or a carbon monoxide detector 76. Some or all of these components may also be included in the base unit 2.

In a preferred form, the base unit 2 of the whole home emergency alert system 3 further includes AM/FM/clock radio circuitry, including a display 44 for displaying at least one of time, information identifying an AM (amplitude modulated) radio station and information identifying an FM (frequency modulated) radio station, and a clock circuit 42 for determining time, the clock circuit 42 being electrically coupled to the display 44. The base unit receiver circuit 16 thus receives at least one of AM signals and FM signals, in addition to receiving the at least one of an NOAA alert signal and an NWS alert signal.

Preferably, the base unit 2 further comprises a panic switch 28. The panic switch 28 is activatable by a user of the whole home emergency alert system 3. The base unit transmitter circuit 18, in response to activation of the base unit panic switch 28, transmits a panic alert signal to the at least one satellite unit 4, and the base unit audio amplifier circuit 26, in response to activation of the base unit panic switch 28, causes the base unit transducer 10 to emit an audible panic alert signal.

In this embodiment of the whole home emergency alert system 3, the satellite unit receiver circuit 48 of the at least one satellite unit 4 receives the panic alert signal transmitted by the base unit transmitter circuit 18. The satellite unit audio amplifier circuit 50, in response to the satellite unit receiver circuit 48 receiving the panic alert signal, causes the satellite unit transducer 12 to emit an audible panic alert signal.

In yet another form of the present invention, the base unit 2 of the whole home emergency alert system 3 further includes an auxiliary power circuit 34, and an emergency light 38, the emergency light 38 being electrically coupled to the auxiliary power circuit 34 and being selectively energized by the auxiliary power circuit 34.

The base unit 2, in another form of the whole home emergency alert system 3, may further include a microphone 32. The microphone 32 is electrically coupled to the base unit transmitter circuit 18. The microphone 32 receives audible voice signals from a user of the whole home emergency alert system 3 and provides electrical voice signals corresponding thereto to the base unit transmitter circuit 18. The base unit transmitter circuit 18 transmits voice signals corresponding to the microphone electrical voice signals to the at least one satellite unit 4. The satellite unit receiver circuit 48 of the at least one satellite unit 4 receives the voice signals transmitted by the base unit transmitter circuit 18. The satellite unit audio amplifier circuit 50, in response to the satellite unit receiver circuit 48 receiving the voice signals transmitted by the base unit transmitter circuit 18, causes the satellite unit transducer 12 to emit audible voice signals.

In another form of the present invention, the base unit 2 of the whole home emergency alert system 3 further includes at least one of a smoke detector circuit and a carbon monoxide detector circuit 76. The at least one of the smoke detector circuit and the carbon monoxide detector circuit 76 generates an output signal when the at least one of the smoke detector circuit and the carbon monoxide detector circuit 76 detects at least one of the presence of smoke and the presence of carbon monoxide. The base unit transmitter circuit 18 transmits a smoke or carbon monoxide detection signal in response to the output signal generated by the at least one of the smoke detector circuit and the carbon monoxide detector circuit 76. The satellite unit receiver circuit 48 of the at least one satellite unit 4 receives the smoke or carbon monoxide detection signal transmitted by the base unit transmitter circuit 18. The satellite unit audio amplifier circuit 50, in response to the satellite unit receiver circuit 48 receiving the smoke or carbon monoxide detection signal, causes the satellite unit transducer 12 to emit an audible warning signal.

As stated previously, the whole home emergency alert system 3 may include a plurality of satellite units 4a-4d (see FIG. 3), such as at least a first satellite unit (e.g., hereinafter, unit 4a) and a second satellite unit (e.g., hereinafter, unit 4b), the second satellite unit 4b being situated remotely from the first satellite unit 4a and the base unit 2. The first satellite unit 4a communicates wirelessly with the second satellite unit 4b.

Preferably, each of the at least first satellite unit 4a and the second satellite unit 4b further includes a housing 15 having a rear surface 13, and power prongs 8 mounted on and extending outwardly from the rear surface 13 of the housing 15 which are receivable by a wall power outlet so that each of the at least first satellite unit 4a and the second satellite unit 4b is mountable on a respective wall power outlet.

As also mentioned previously, the first satellite unit 4a includes the satellite unit receiver circuit 48 and further includes a transmitter circuit 52, the satellite unit transmitter circuit 52 of the first satellite unit 4a being electrically coupled to the satellite unit receiver circuit 48 of the first satellite unit 4a. The satellite unit transmitter circuit 52 of the first satellite unit 4a may transmit an alert signal to the second satellite unit 4b in response to the satellite unit receiver circuit 48 of the first satellite unit 4a receiving the emergency alert signal transmitted by the base unit 2.

In this embodiment, the second satellite unit 4b includes the satellite unit receiver circuit 48, the satellite unit audio amplifier circuit 50 and the satellite unit transducer 12, as also mentioned previously. The satellite unit receiver circuit 48 of the second satellite unit 4b receives the alert signal transmitted by the satellite unit transmitter circuit 52 of the first satellite unit 4a. The satellite unit audio amplifier circuit 50 of the second satellite unit 4b, in response to the satellite unit receiver circuit 48 of the second satellite unit 4b receiving the alert signal transmitted by the transmitter circuit 52 of the first satellite unit 4a, may cause the satellite unit transducer 12 of the second satellite unit 4b to emit an audible alert signal.

In yet another form of the whole home emergency alert system 3 of the present invention, the first satellite unit 4a preferably includes the satellite unit transmitter circuit 52, the satellite unit audio amplifier circuit 50 and the satellite unit transducer 12, and the second satellite unit 4b preferably includes the satellite unit receiver circuit 48, the satellite unit audio amplifier circuit 50 and the satellite unit transducer 12. Also, in this embodiment, at least the first satellite unit 4a further includes a panic switch 58, the panic switch 58 being activatable by a user of the whole home emergency alert system 3. The satellite unit transmitter circuit 52 of the first satellite unit 4a, in response to activation of the satellite unit panic switch 58 of the first satellite unit 4a, transmits a panic alert signal to at least one of the second satellite unit 4b and the base unit 2. The satellite unit audio amplifier circuit 50 of the first satellite unit 4a, in response to activation of the panic switch 58 of the first satellite unit 4a, causes the transducer 12 of the first satellite unit 4a to emit an audible panic alert signal. Furthermore, or alternatively, at least one of the receiver circuit 16 of the base unit 2 and the receiver circuit 48 of the second satellite unit 4b receives the panic alert signal transmitted by the transmitter circuit 52 of the first satellite unit 4a, and at least one of the audio amplifier circuit 26 of the base unit 2 and the audio amplifier circuit 50 of the second satellite unit 4b, in response to at least one of the receiver circuit 16 of the base unit 2 and the receiver circuit 48 of the second satellite unit 4b receiving the panic alert signal transmitted by the transmitter circuit 52 of the first satellite unit 4a, causes at least one of the transducer 10 of the base unit 2 and the transducer 12 of the second satellite unit 4b to emit an audible panic alert signal.

In yet another form of the present invention, the at least one satellite unit 4 of the whole home emergency alert system 3 further includes an auxiliary power circuit 62, and an emergency light 66, the emergency light 66 being electrically coupled to the auxiliary power circuit 62 and being selectively energized by the auxiliary power circuit 62.

In still a further form of the present invention, the at least one satellite unit 4 of the whole home emergency alert system 3 further includes a nightlight circuit 67. Preferably, the nightlight circuit 67 includes a nightlight control circuit 70, a photosensor 68 electrically coupled to the nightlight control circuit 70 and generating an output signal corresponding to ambient light conditions detected by the photosensor 68, and a light source 72, the light source 72 being electrically coupled to the nightlight control circuit 70. The nightlight control circuit 70 selectively energizes the light source 72 in response to the output signal generated by the photosensor 68, and the light source 72 emits a light when energized by the nightlight control circuit 70.

In yet another embodiment of the whole home emergency alert system 3, the first satellite unit 4a includes the satellite unit transmitter circuit 52, and the second satellite unit 4b includes the satellite unit receiver circuit 48, the satellite unit audio amplifier circuit 50 and the satellite unit transducer 12. In this embodiment, the first satellite unit 4a further includes a microphone 54. The microphone 54 is electrically coupled to the transmitter circuit 52 of the first satellite unit 4a. The microphone 54 receives audible voice signals from a user of the whole home emergency alert system 3 and provides electrical voice signals corresponding thereto to the transmitter circuit 52 of the first satellite unit 4a. The transmitter circuit 52 of the first satellite unit 4a transmits voice signals corresponding to the microphone electrical voice signals to at least one of the second satellite unit 4b and the base unit 2.

Furthermore, at least one of the receiver circuit 48 of the second satellite unit 4b and the receiver circuit 16 of the base unit 2 receives the voice signals transmitted by the transmitter circuit 52 of the first satellite unit 4a. At least one of the audio amplifier circuit 26 of the base unit 2 and the audio amplifier circuit 50 of the second satellite unit 4b, in response to the at least one of the receiver circuit 16 of the base unit 2 and the receiver circuit 48 of the second satellite unit 4b receiving the voice signals transmitted by the transmitter circuit 52 of the first satellite unit 4a, causes at least one of the transducer 10 of the base unit 2 and the transducer 12 of the second satellite unit 4b to emit audible voice signals.

In still another form of the whole home emergency alert system 3 of the present invention, the first satellite unit 4a includes the satellite unit transmitter circuit 52, and the second satellite unit 4b includes the satellite unit receiver circuit 48, the satellite unit audio amplifier circuit 50 and the satellite unit transducer 12. In addition, the first satellite unit 4a includes at least one of a smoke detector circuit and a carbon monoxide detector circuit 76. The at least one of the smoke detector circuit and the carbon monoxide detector circuit 76 of the first satellite unit 4a generates an output signal when the at least one of the smoke detector circuit and the carbon monoxide detector circuit 76 of the first satellite unit 4a detects at least one of the presence of smoke and the presence of carbon monoxide. The transmitter circuit 52 of the first satellite unit 4a transmits a smoke or carbon monoxide detection signal in response to the output signal generated by the at least one of the smoke detector circuit and the carbon monoxide detector circuit 76 of the first satellite unit 4a.

At least one of the receiver circuit 16 of the base unit 2 and the receiver circuit 48 of the second satellite unit 4b receives the smoke or carbon monoxide detection signal transmitted by the transmitter circuit 52 of the first satellite unit 4a. At least one of the audio amplifier circuit 26 of the base unit 2 and the audio amplifier circuit 50 of the second satellite unit 4b, in response to the at least one of the receiver circuit 16 of the base unit 2 and the receiver circuit 48 of the second satellite unit 4b receiving the smoke or carbon monoxide detection signal transmitted by the transmitter circuit 52 of the first satellite unit 4a, causes at least one of the transducer 10 of the base unit 2 and the transducer 12 of the second satellite unit 4b to emit an audible warning signal.

Although illustrative embodiments of the present invention have been described herein with reference to the accompanying drawings, it is to be understood that the invention is not limited to those precise embodiments and that various other changes and modifications may be effected herein by one skilled in the art without departing from the scope or spirit of the invention.

What is claimed is:

1. A whole home emergency alert system, which comprises:
a base unit; and
at least one satellite unit, the at least one satellite unit being remotely situated from the base unit;
wherein the base unit communicates wirelessly with the at least one satellite unit;
wherein the base unit includes an emergency signal receiver circuit which receives at least one of an NOAA (National Oceanic and Atmospheric Administration) alert signal and an NWS (National Weather Service) alert signal;
wherein the base unit further includes a transmitter circuit, the base unit transmitter circuit being electrically coupled to the base unit receiver circuit and transmitting an emergency alert signal to the at least one satellite unit in response to the base unit receiver circuit receiving the at least one of the NOAA alert signal and the NWS alert signal;
wherein the base unit further includes an audio amplifier circuit and a transducer electrically coupled to the base unit audio amplifier circuit, the base unit audio amplifier circuit being electrically coupled to the base unit receiver circuit and causing the base unit transducer to emit an audible warning signal in response to the base unit receiver circuit receiving the at least one of the NOAA alert signal and the NWS alert signal;
wherein the at least one satellite unit includes a receiver circuit which receives the emergency alert signal transmitted by the base unit; and
wherein the at least one satellite unit further includes an audio amplifier circuit and a transducer electrically coupled to the satellite unit audio amplifier circuit, the satellite unit audio amplifier circuit being electrically coupled to the satellite unit receiver circuit and causing the satellite unit transducer to emit an audible warning signal in response to the satellite unit receiver circuit receiving the emergency alert signal transmitted by the base unit.

2. A whole home emergency alert system as defined by claim 1, wherein the base unit further includes AM/FM/clock radio circuitry, including:
a display for displaying at least one of time, information identifying an AM (amplitude modulated) radio station and information identifying an FM (frequency modulated) radio station; and
a clock circuit for determining time, the clock circuit being electrically coupled to the display;
wherein the base unit receiver circuit receives at least one of AM signals and FM signals, in addition to receiving the at least one of an NOAA alert signal and an NWS alert signal.

3. A whole home emergency alert system as defined by claim 1, wherein the base unit further comprises a panic switch, the panic switch being activatable by a user of the whole home emergency alert system, the base unit transmitter circuit, in response to activation of the base unit panic switch, transmitting a panic alert signal to the at least one satellite unit, the base unit audio amplifier circuit, in response to activation of the base unit panic switch, causing the base unit transducer to emit an audible panic alert signal; and
wherein the satellite unit receiver circuit of the at least one satellite unit receiving the panic alert signal transmitted by the base unit transmitter circuit, the satellite unit audio amplifier circuit, in response to the satellite unit receiver circuit receiving the panic alert signal, causing the satellite unit transducer to emit an audible panic alert signal.

4. A whole home emergency alert system as defined by claim 1, wherein the base unit further includes:
an auxiliary power circuit; and
an emergency light, the emergency light being electrically coupled to the auxiliary power circuit and being selectively energized by the auxiliary power circuit.

5. A whole home emergency alert system as defined by claim 1, wherein the base unit further includes:
a microphone, the microphone being electrically coupled to the base unit transmitter circuit, the microphone receiving audible voice signals from a user of the whole home emergency alert system and providing electrical voice signals corresponding thereto to the base unit transmitter circuit, the base unit transmitter circuit transmitting voice signals corresponding to the microphone electrical voice signals to the at least one satellite unit; and
wherein the satellite unit receiver circuit of the at least one satellite unit receiving the voice signals transmitted by the base unit transmitter circuit, the satellite unit audio amplifier circuit, in response to the satellite unit receiver circuit receiving the voice signals transmitted by the base unit transmitter circuit, causing the satellite unit transducer to emit audible voice signals.

6. A whole home emergency alert system as defined by claim 1, wherein the base unit further includes:
at least one of a smoke detector circuit and a carbon monoxide detector circuit, the at least one of the smoke detector circuit and the carbon monoxide detector circuit generating an output signal when the at least one of the smoke detector circuit and the carbon monoxide detector circuit detects at least one of the presence of smoke and the presence of carbon monoxide, the base unit transmitter circuit transmitting a smoke or carbon monoxide detection signal in response to the output signal generated by the at least one of the smoke detector circuit and the carbon monoxide detector circuit; and
wherein the satellite unit receiver circuit of the at least one satellite unit receiving the smoke or carbon monoxide detection signal transmitted by the base unit transmitter circuit, the satellite unit audio amplifier circuit, in response to the satellite unit receiver circuit receiving the smoke or carbon monoxide detection signal, causing the satellite unit transducer to emit an audible warning signal.

7. A whole home emergency alert system as defined by claim 1, wherein the at least one satellite unit includes at least a first satellite unit and a second satellite unit, the second satellite unit being situated remotely from the first satellite unit and the base unit; and
wherein the first satellite unit communicates wirelessly with the second satellite unit.

8. A whole home emergency alert system as defined by claim 7, wherein each of the at least first satellite unit and the second satellite unit further includes a housing having a rear surface, and power prongs mounted on and extending outwardly from the rear surface of the housing which are receivable by a wall power outlet so that each of the at least first satellite unit and the second satellite unit is mountable on a respective wall power outlet.

9. A whole home emergency alert system as defined by claim 7, wherein the first satellite unit includes the satellite unit receiver circuit and further includes a transmitter circuit, the satellite unit transmitter circuit of the first satellite unit being electrically coupled to the satellite unit receiver circuit of the first satellite unit, the satellite unit transmitter circuit of the first satellite unit transmitting an alert signal to the second satellite unit in response to the satellite unit receiver circuit of the first satellite unit receiving the emergency alert signal transmitted by the base unit; and
wherein the second satellite unit includes the satellite unit receiver circuit, the satellite unit audio amplifier circuit and the satellite unit transducer; and
wherein the satellite unit receiver circuit of the second satellite unit receives the alert signal transmitted by the satellite unit transmitter circuit of the first satellite unit, the satellite unit audio amplifier circuit of the second satellite unit, in response to the satellite unit receiver circuit of the second satellite unit receiving the alert signal transmitted by the transmitter circuit of the first satellite unit, causing the satellite unit transducer of the second satellite unit to emit an audible alert signal.

10. A whole home emergency alert system as defined by claim 7, wherein the first satellite unit includes the satellite unit transmitter circuit, the satellite unit audio amplifier circuit and the satellite unit transducer;
wherein the second satellite unit includes the satellite unit receiver circuit, the satellite unit audio amplifier circuit and the satellite unit transducer;
wherein at least the first satellite unit further includes a panic switch, the panic switch being activatable by a user of the whole home emergency alert system, the satellite unit transmitter circuit of the first satellite unit, in response to activation of the satellite unit panic switch of the first satellite unit, transmitting a panic alert signal to at least one of the second satellite unit and the base unit, the satellite unit audio amplifier circuit of the first satellite unit, in response to activation of the panic switch of the first satellite unit, causing the transducer of the first satellite unit to emit an audible panic alert signal; and
wherein at least one of the receiver circuit of the base unit and the receiver circuit of the second satellite unit receiving the panic alert signal transmitted by the transmitter circuit of the first satellite unit, at least one of the audio amplifier circuit of the base unit and the audio amplifier circuit of the second satellite unit, in response to at least one of the receiver circuit of the base unit and the receiver circuit of the second satellite unit receiving the panic alert signal transmitted by the transmitter circuit of the first satellite unit, causing at least one of the transducer of the base unit and the transducer of the second satellite unit to emit an audible panic alert signal.

11. A whole home emergency alert system as defined by claim 1, wherein the at least one satellite unit further includes:
an auxiliary power circuit; and
an emergency light, the emergency light being electrically coupled to the auxiliary power circuit and being selectively energized by the auxiliary power circuit.

12. A whole home emergency alert system as defined by claim 1, wherein the at least one satellite unit further includes:
a nightlight circuit, the nightlight circuit including a nightlight control circuit, a photosensor electrically coupled to the nightlight control circuit and generating an output signal corresponding to ambient light conditions detected by the photosensor, and a light source, the light source being electrically coupled to the nightlight control circuit, the nightlight control circuit selectively energizing the light source in response to the output signal generated by the photosensor, the light source emitting a light when energized by the nightlight control circuit.

13. A whole home emergency alert system as defined by claim 7, wherein the first satellite unit includes the satellite unit transmitter circuit;
wherein the second satellite unit includes the satellite unit receiver circuit, the satellite unit audio amplifier circuit and the satellite unit transducer;
wherein the first satellite unit further includes a microphone, the microphone being electrically coupled to the transmitter circuit of the first satellite unit, the microphone receiving audible voice signals from a user of the whole home emergency alert system and providing electrical voice signals corresponding thereto to the transmitter circuit of the first satellite unit, the transmitter circuit of the first satellite unit transmitting voice signals corresponding to the microphone electrical voice signals to at least one of the second satellite unit and the base unit; and
wherein at least one of the receiver circuit of the second satellite unit and the receiver circuit of the base unit receiving the voice signals transmitted by the transmitter circuit of the first satellite unit, at least one of the audio amplifier circuit of the base unit and the audio amplifier circuit of the second satellite unit, in response to the at least one of the receiver circuit of the base unit and the receiver circuit of the second satellite unit receiving the voice signals transmitted by the transmitter circuit of the first satellite unit, causing at least one of the transducer of the base unit and the transducer of the second satellite unit to emit audible voice signals.

14. A whole home emergency alert system as defined by claim 7, wherein the first satellite unit includes the satellite unit transmitter circuit;
wherein the second satellite unit includes the satellite unit receiver circuit, the satellite unit audio amplifier circuit and the satellite unit transducer;
wherein the first satellite unit further includes at least one of a smoke detector circuit and a carbon monoxide detector circuit, the at least one of the smoke detector circuit and the carbon monoxide detector circuit of the first satellite unit generating an output signal when the at least one of the smoke detector circuit and the carbon monoxide detector circuit of the first satellite unit detects at least one of the presence of smoke and the presence of carbon monoxide, the transmitter circuit of the first satellite unit transmitting a smoke or carbon monoxide detection signal in response to the output signal generated by the at least one of the smoke detector circuit and the carbon monoxide detector circuit of the first satellite unit; and
wherein at least one of the receiver circuit of the base unit and the receiver circuit of the second satellite unit receiving the smoke or carbon monoxide detection signal transmitted by the transmitter circuit of the first satellite unit, at least one of the audio amplifier circuit of the base unit and the audio amplifier circuit of the second satellite unit, in response to the at least one of the receiver circuit of the base unit and the receiver circuit of the second satellite unit receiving the smoke or carbon monoxide detection signal transmitted by the transmitter circuit of the first satellite unit, causing at least one of the transducer of the base unit and the transducer of the second satellite unit to emit an audible warning signal.
